(19) United States
(12) Patent Application Publication
(10) Pub. No.: US 2025/0020862 A1
(43) Pub. Date: Jan. 16, 2025

(54) Optical Module

(71) Applicant: HISENSE BROADBAND MULTIMEDIA TECHNOLOGIES CO., LTD., Qingdao (CN)

(72) Inventors: Qian SHAO, Qingdao (CN); Weiwei Liu, Qingdao (CN); Qiang Zhang, Qingdao (CN); Xiaokuo Zhang, Qingdao (CN)

(73) Assignee: HISENSE BROADBAND MULTIMEDIA TECHNOLOGIES CO., LTD., Qingdao (CN)

(21) Appl. No.: 18/900,465

(22) Filed: Sep. 27, 2024

Related U.S. Application Data
(63) Continuation of application No. PCT/CN2023/080562, filed on Mar. 9, 2023.

(30) Foreign Application Priority Data
Sep. 9, 2022 (CN) 202222412337.6
Sep. 29, 2022 (CN) 2022 1 1202819.7
Sep. 29, 2022 (CN) 2022 1 1204022.0

(51) Int. Cl. G02B 6/12; G02B 6/38; H04B 10/40; H04B 10/50; H04B 10/516

(52) U.S. Cl. CPC G02B 6/12; H04B 10/40; H04B 10/503; H04B 10/516; G02B 2006/12142; G02B 6/3861

(57) ABSTRACT

An optical module including an optical transceiver component having a transceiver case and a first circuit board. The transceiver case is formed, at a first end, with a through-channel and, at a second end, with an insertion port for inserting the first circuit board, optical components including a laser chip, an optical modulation chip, an optical reception chip and the like are arranged in the transceiver case. The first circuit board has a notch. The optical modulation chip is located corresponding to the notch and includes an optical modulation film layer laid on a substrate. A first bonding pad is provided on the optical modulation film layer, which is electrically connected to the first circuit board; an arc-shaped optical waveguide is provided inside the optical modulation film layer, light inlet and outlet of which are located at the same end of the optical modulation film layer.

### CROSS-REFERENCE TO RELATED APPLICATIONS

This application is a continuation of PCT/CN2023/080562 filed on Mar. 9, 2023, which claims priority to Chinese Application No. 202211204022.0, filed on Sep. 29, 2022, with the China National Intellectual Property Administration (CNIPA); Chinese Application No. 202211202819.7, filed on Sep. 29, 2022, with the CNIPA; and Chinese Application No. 202222412337.6, filed on Sep. 9, 2022, with the CNIPA, the entire disclosures of which are incorporated herein by reference.

### FIELD

The present disclosure relates to the field of optical communication technology, and in particular, to an optical module.

### BACKGROUND

With the development of new services and application models such as cloud computing, mobile internet, and video, the development and progress of optical communication technology have become increasingly important. In the optical communication technology, optical module is a tool for achieving interconversion between an optical signal and an electrical signal, and is one of the key components in optical communication equipment. In addition, with the development of optical communication technology, it is required that the transmission rate of optical module constantly increases.

### SUMMARY

The present disclosure provides an optical module including an optical transceiver component. The optical transceiver component includes a transceiver case and a first circuit board. The transceiver case has a through-channel at a first end thereof and an insertion port at a second end thereof, wherein the insertion port is configured such that the first circuit board is inserted into the transceiver case through the insertion port, and an optical component is disposed inside the transceiver case. The first circuit board is provided with a notch. The optical component includes a laser chip, a first lens, an optical modulation chip, a second lens, a filter, a third lens, a receiving-turning prism and an optical reception chip. The laser chip, the first lens, the second lens, the filter, the third lens, the receiving-turning prism and the optical reception chip are all located at the first end of the transceiver case, and the optical modulation chip is located at the second end of the transceiver case. The first lens is located between the laser chip and the optical modulation chip. The optical modulation chip is arranged corresponding to the notch, and includes a substrate and an optical modulation film layer. The optical modulation film layer is laid on the substrate. The second lens is located between the optical modulation chip and the filter. A first bonding pad is arranged on a surface of the optical modulation film layer, and is electrically connected to the first circuit board; an arc-shaped optical waveguide is arranged inside the optical modulation film layer, and an light inlet and an light outlet of the optical waveguide are located at the same end of the optical modulation film layer; the filter is located between the laser chip and the third lens, and the receiving-turning prism is located above the optical reception chip.

The present disclosure also provides an optical module including an optical transceiver component. The optical transceiver component includes a transceiver case, a first circuit board and an optical fiber adapter, wherein a through-channel is provided at a first end of the transceiver case, and the optical fiber adapter is connected to the through-channel; an insertion port is provided at a second end of the transceiver case, the insertion port is configured for the first circuit board to be inserted into the transceiver case; and an optical component is disposed inside the transceiver case. The first circuit board is provided with a notch; the optical component comprises a laser chip, an optical modulation chip and an optical reception chip. Wherein the laser chip and the optical reception chip are both located at the first end of the transceiver case, and the optical modulation chip is located at the second end of the transceiver case; the optical modulation chip is arranged corresponding to the notch; a light outlet of the optical modulation chip faces the optical fiber adapter; a light exit direction of the laser chip is away from the optical fiber adapter and towards a light inlet of the optical modulation chip. The transceiver case includes: a transceiver seat, one end of which is provided with the through-channel, and the other end of which is provided with the insertion port; and an upper cover, which covers the transceiver seat.

### BRIEF DESCRIPTION OF DRAWINGS

The accompanying drawings to be used in describing the prior art or embodiments of the present disclosure will be described briefly below so as to more clearly describe the technical solutions the embodiments of the present disclosure. Apparently, the accompanying drawings described below are only those of some embodiments of the present disclosure, and for those skilled in the art, other drawings may also be derived from these accompanying drawings without making any creative work.

FIG. 1 is a connection diagram of an optical communication system provided according to some embodiments of the present disclosure.

FIG. 2 is a structural diagram of an optical network terminal provided according to some embodiments of the present disclosure.

FIG. 3 is a structural diagram of an optical module provided according to some embodiments of the present disclosure.

FIG. 4 is a diagram showing an exploded structure of an optical module according to some embodiments of the present disclosure.

FIG. 5 is a structural diagram of an optical module, without the upper shell, according to some embodiments of the present disclosure.

FIG. 6 is a structural diagram of an optical transceiver component and a circuit board according to some embodiments of the present disclosure.

FIG. 7 is a first structural diagram of an optical transceiver component provided according to some embodiments of the present disclosure.

FIG. 8 is a first sectional view of an optical transceiver component provided according to some embodiments of the present disclosure.

FIG. 9 is a second sectional view of an optical transceiver component provided according to some embodiments of the present disclosure.

FIG. 10 is a third sectional view of an optical transceiver component provided according to some embodiments of the present disclosure.

FIG. 11 is a structural diagram of an optical transceiver component, without the upper cover, according to some embodiments of the present disclosure.

FIG. 12 is a structural diagram of an optical component and a first circuit board according to some embodiments of the present disclosure.

FIG. 13 is a structural diagram of an optical component provided according to some embodiments of the present disclosure.

FIG. 14 is a structural diagram of a first circuit board provided according to some embodiments of the present disclosure.

FIG. 15 is a structural diagram of an optical fiber adapter, a focusing ring, a fourth lens, and a lens-fixing seat according to some embodiments of the present disclosure.

FIG. 16 is an exploded view of an optical fiber adapter, a focusing ring, a fourth lens, and a lens-fixing seat according to some embodiments of the present disclosure.

FIG. 17 is a first structural diagram of a transceiver seat provided according to some embodiments of the present disclosure.

FIG. 18 is a second structural diagram of a transceiver seat provided according to some embodiments of the present disclosure.

FIG. 19 is an exploded view of a transceiver seat according to some embodiments of the present disclosure.

FIG. 20 is a first sectional view of a transceiver seat according to some embodiments of the present disclosure.

FIG. 21 is a second sectional view of a transceiver seat according to some embodiments of the present disclosure.

FIG. 22 is a first diagram showing an optical path of an optical module provided according to some embodiments of the present disclosure.

FIG. 23 is a second diagram showing an optical path of an optical module provided according to some embodiments of the present disclosure.

FIG. 24 is a schematic diagram showing a connection configuration between an optical transceiver component and a circuit board according to some embodiments of the present disclosure.

FIG. 25 is a structural schematic diagram of an optical transceiver component and a circuit board which are separated according to some embodiments of the present disclosure.

FIG. 26 is a structural schematic diagram of an optical fiber adapter and an optical transceiver component according to some embodiments of the present disclosure.

FIG. 27 is an exploded view of a structure of an optical fiber adapter provided according to some embodiments of the present disclosure.

FIG. 28 is a sectional schematic diagram of an optical fiber adapter provided according to some embodiments of the present disclosure.

FIG. 29 is a schematic sectional view of an optical transceiver component according to some embodiments of the present disclosure.

FIG. 30 is a schematic diagram of a partial structure of an optical transceiver component provided according to some embodiments of the present disclosure.

### DETAILED DESCRIPTION

Technical solutions of some embodiments of this disclosure will be described clearly and in detail with reference to the accompanying drawings below. Obviously, these embodiments are merely some, but not all, of the embodiments of this disclosure. All other embodiments obtained by those skilled in the art based on the embodiments of this disclosure fall within the protection scope of this disclosure.

The term “comprise” and other forms thereof such as the third-person singular form “comprises” and the present participle form “comprising” should be construed as open and inclusive, i.e., “including, but not limited to”, throughout the description and the claims unless the context indicates otherwise, In the description, terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Thus, features defined as “first” and “second” may explicitly or implicitly include one or more of the features. In the description of the embodiments of the present disclosure, the term “a plurality of” means two or more.

In the description of some embodiments, the terms “coupled” and “connected” and their extensions may be used. The term “connected” should be understood in a broad sense. For example, the term “connected” may mean two or more components are fixedly connected or detachably connected, or integrated; they may be directly connected or indirectly connected through one or more intermediate medium. For example, the term “connected” may be used in the description of some embodiments to indicate that two or more components are in direct or indirect physical or electrical contact with each other. For another example, the term “coupled” may be used in the description of some embodiments to indicate that two or more components are in direct or indirect physical or electrical contact. However, the term “coupled” or “communicatively coupled” may also mean that two or more components are not in direct contact with each other, but still cooperate or interact with each other. The embodiments disclosed herein are not necessarily limited to the contents herein.

The phrase “at least one of A, B and C” has the same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The use of the phrase “applicable to” or “configured to” herein means an open and inclusive language, which does not exclude devices that are applicable to or configured to perform additional tasks or steps.

The term “about”, “substantially” or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

As used herein, “parallel”, “perpendicular”, and “equal” include the described situations and situations similar to the described situations, and the range of the similar situations is within the acceptable range of deviation, wherein the acceptable range of deviation is determined by a person of ordinary skill in the art taking into account the measurement being discussed and the errors associated with the measurement of a particular quantity (i.e., the limitations of the measurement system). For example, “parallel” includes absolute parallelism and approximate parallelism, wherein the acceptable range of deviation of approximate parallelism can be, for example, a deviation within 5°; “perpendicular” includes absolute perpendicularity and approximate perpendicularity, wherein the acceptable deviation range of approximate perpendicularity can also be, for example, a deviation within 5°; “equal” includes absolute equality and approximate equality, wherein the acceptable deviation range of approximate equality can be, for example, the difference between the two equalities is less than or equal to 5% of either one.

In optical communication technology, an optical signal is used to carry information to be transmitted, and the optical signal carrying the information is transmitted to an information processing device such as a computer through an information transmission device such as an optical fiber or an optical waveguide to complete transmission of the information. Since the light has a characteristic of passive transmission when being transmitted through the optical fiber or the optical waveguide, low-cost and low-loss information transmission may be achieved. In addition, a signal transmitted by the information transmission device such as the optical fiber or the optical waveguide is an optical signal, while a signal that can be recognized and processed by the information processing device such as the computer is an electrical signal. Therefore, in order to establish information connection between the information transmission device such as the optical fiber or the optical waveguide and the information processing device such as the computer, it is necessary to achieve interconversion between the electrical signal and the optical signal.

An optical module is provided to perform mutual conversion between the optical signal and the electrical signal in the field of optical communication technology. The optical module includes an optical port and an electrical port. Optical communication between the optical module and the information transmission device such as the optical fiber or the optical waveguide is achieved through the optical port. Electrical connection between the optical module and an optical network terminal (e.g., an optical modem) is achieved through the electrical port. The electrical connection is mainly to achieve power supply, transmission of an I2C signal, transmission of a data information and grounding. The optical network terminal transmits the electrical signal to the information processing device such as the computer through a network cable or wireless fidelity technology (Wi-Fi).

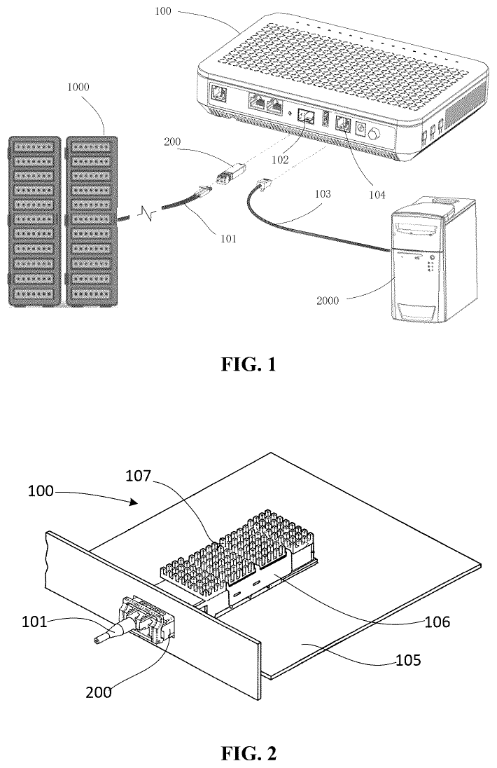

FIG. 1 is a diagram showing a connection relationship of an optical communication system provided according to some embodiments of the present application. As shown in FIG. 1, the optical communication system includes a remote server 1000, a local information processing device 2000, an optical network terminal 100, an optical module 200, an optical fiber 101 and a network cable 103.

One terminal of the optical fiber 101 is connected to the remote server 1000, and the other terminal of the optical fiber 101 is connected to the optical network terminal 100 through the optical module 200. The optical fiber itself may support long-distance signal transmission, such as several-kilometer (6-8 kilometers) signal transmission. Based on this, if a repeater is used, infinite-distance transmission may be achieved theoretically. Therefore, in an optical communication system, a distance between the remote server 1000 and the optical network terminal 100 may reach several kilometers, tens of kilometers, or hundreds of kilometers.

One terminal of the network cable 103 is connected to the local information processing device 2000, and the other terminal of the network cable 103 is connected to the optical network terminal 100. The local information processing device 2000 may be at least one of the followings: a router, a switch, a computer, a mobile phone, a tablet computer, a television or the like.

A physical distance between the remote server 1000 and the optical network terminal 100 is greater than a physical distance between the local information processing device 2000 and the optical network terminal 100. Connection between the local information processing device 2000 and the remote server 1000 is completed by the optical fiber 101 and the network cable 103, and connection between the optical fiber 101 and the network cable 103 is completed by the optical module 200 and the optical network terminal 100.

The optical module 200 includes the optical port and the electrical port. The optical port is configured to be connected with the optical fiber 101, such that a bidirectional optical signal connection is established between the optical module 200 and the optical fiber 101. The electrical port is configured to access the optical network terminal 100, such that a bidirectional electrical signal connection is established between the optical module 200 and the optical network terminal 100. Interconversion between the optical signal and the electrical signal is achieved by the optical module 200, such that connection between the optical fiber 101 and the optical network terminal 100 is established. For example, an optical signal from the optical fiber 101 is converted into an electrical signal by the optical module 200, and then the electrical signal is input into the optical network terminal 100; an electrical signal from the optical network terminal 100 is converted into an optical signal by the optical module 200, and then the optical signal is input into the optical fiber 101. The optical module 200 is a tool to realize the mutual conversion between the optical signal and the electrical signal, it does not have the function of processing data, and thus the information is not changed during the above mentioned photoelectric conversion.

The optical network terminal 100 includes a housing which is substantially in a cuboid shape, and an optical module interface 102 and a network cable interface 104 that are disposed on the housing. The optical module interface 102 is configured to access the optical module 200, such that a bidirectional electrical signal connection is established between the optical network terminal 100 and the optical module 200. The network cable interface 104 is configured to access the network cable 103, such that a bidirectional electrical signal connection is established between the optical network terminal 100 and the network cable 103. Connection between the optical module 200 and the network cable 103 is established through the optical network terminal 100. For example, the optical network terminal 100 transmits an electrical signal from the optical module 200 to the network cable 103, and transmits an electrical signal from the network cable 103 to the optical module 200. Therefore, the optical network terminal 100, as a master monitor of the optical module 200, may monitor operation of the optical module 200. In addition to the optical network terminal 100, the master monitor of the optical module 200 may further include an optical line terminal (OLT) and the like.

A bidirectional signal transmission channel is established between the remote server 1000 and the local information processing device 2000 through the optical fiber 101, the optical module 200, the optical network terminal 100 and the network cable 103.

FIG. 2 is a structural diagram of an optical network terminal provided according to some embodiments of this application. FIG. 2 only shows structures of the optical network terminal 100 that are related to the optical module 200 so as to clearly show a connection relationship between the optical module 200 and the optical network terminal 100. As shown in FIG. 2, the optical network terminal 100 further includes a circuit board 105 disposed in the housing, a cage 106 disposed on a surface of the circuit board 105, a heat sink 107 disposed on the cage 106, and an electrical connector disposed inside the cage 106. The electrical connector is configured to access the electrical port of the optical module 200; the heat sink 107 has protruding structures such as fins for increasing a heat dissipation area.

The optical module 200 is inserted into the cage 106 of the optical network terminal 100, the optical module 200 is fixed by the cage 106, and heat generated by the optical module 200 is conducted to the cage 106 and is dissipated through the heat sink 107. After the optical module 200 is inserted into the cage 106, the electrical port of the optical module 200 is connected to the electrical connector in the cage 106, and thus the bidirectional electrical signal connection is established between the optical module 200 and the optical network terminal 100. In addition, the optical port of the optical module 200 is connected to the optical fiber 101, such that the bidirectional optical signal connection is established between the optical module 200 and the optical fiber 101.

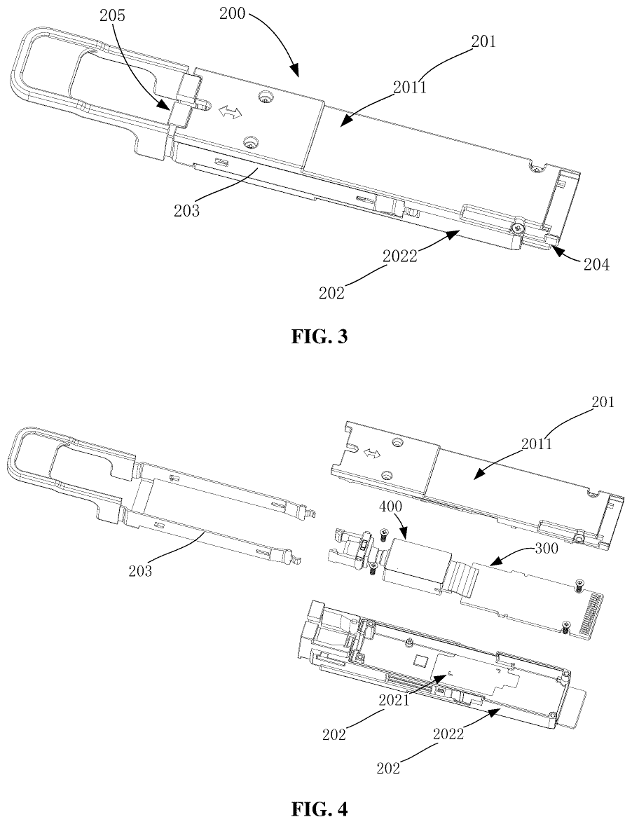

FIG. 3 is a structural diagram of an optical module provided in accordance with some embodiments of the present disclosure, and FIG. 4 is a partial exploded diagram of an optical module provided in accordance with some embodiments of the present disclosure. As shown in FIGS. 3 and 4, the optical module 200 includes a shell, a circuit board 300 disposed in the shell and an optical transceiver component 400.

The shell includes a lower shell 202 and an upper shell 201 covers on the lower shell 202 to form the shell with two openings. An outer contour of the shell may be in a cuboid shape.

In some embodiments of this disclosure, the lower shell 202 includes a bottom plate and two lower side plates located on opposite sides of the bottom plate 2021 and disposed perpendicular to the bottom plate 2021; the upper shell 201 includes a cover plate covers on the two lower side plates 2022 of the lower shell 202 to form the above mentioned shell.

In some embodiments, the lower shell 202 includes a bottom plate 2021 and two lower side plates 2022 located on both sides of the bottom plate 2021 and disposed perpendicular to the bottom plate 2021; the upper shell 201 include a cover plate 2011 and two upper side plates located on both sides of the cover plate 2011 and disposed perpendicular to the cover plate 2011, and the two upper side plates are combined with the two lower side plates 2022 such that the upper shell 201 covers the lower shell 202.

A direction of a connecting line between the two openings 204 and 205 may be the same as a length direction of the optical module 200, or may not be the same as the length direction of the optical module 200. For example, the opening 204 is located at an end (a right end in FIG. 3) of the optical module 200, and the opening 205 is also located at an end (a left end in FIG. 3) of the optical module 200. Alternatively, the opening 204 is located at an end of the optical module 200, and the opening 205 is located at a side of the optical module 200. The opening 204 is the electrical port, and a gold finger 301 of the circuit board 300 extends from the electrical port 204, and is inserted into the master monitor (e.g., the optical network terminal 100); the opening 205 is the optical port, which is configured to access the external optical fiber 101, such that the optical fiber 101 is connected to the optical transceiver component 400 of the optical module 200.

By using an assembly mode of combining the upper shell 201 with the lower shell 202, it facilitates installation of the circuit board 30, the optical transceiver component 400 and other components into the shell, and the upper shell 201 and the lower shell 202 may form encapsulation and protection for these components. In addition, it facilitates to arrange positioning components, heat dissipation components, and electromagnetic shielding components of these devices when assembling the circuit board 30, the optical transceiver component 400 and other components, which is conducive to implementation of automated production.

In some embodiments, the upper shell 201 and the lower shell 202 are generally made of a metallic material, which facilitates electromagnetic shielding and heat dissipation.

In some embodiments, the optical module 200 further includes an unlocking component 203 located outside of the shell thereof, and the unlocking component 203 is configured to achieve or release a fixed connection between the optical module 200 and the master monitor.

For example, the unlocking component 203 is located on outer walls of the two lower side plates 2022 of the lower shell 202, and includes an engagement component that is matched with the cage of the master monitor (e.g., the cage 106 of the optical network terminal 100). When the optical module 200 is inserted into the cage of the master monitor, the optical module 200 is fixed in the cage of the master monitor via the engagement component of the unlocking component. When the unlocking component 203 is pulled, the engagement component of the unlocking component moves therewith, which in turn changes a connection relationship between the engagement component and the master monitor so as to release engagement between the optical module 200 and the master monitor, such that the optical module 200 may be drawn out of the cage of the master monitor.

The circuit board 300 includes circuit wires, electronic elements, chips and the like. The electronic elements and the chips are connected together through the circuit wires according to a circuit design, so as to achieve functions of power supply, electrical signal transmission, grounding and the like. The electronic elements may include, for example, capacitors, resistors, triodes, and metal-oxide-semiconductor field-effect transistors (MOSFETs). The chips may include, for example, a microcontroller unit (MCU), a laser driver chip, a limiting amplifier, a clock and data recovery (CDR) chip, a power management chip, and a digital signal processing (DSP) chip.

The circuit board 300 may be a rigid circuit board which may further achieve a load-bearing function due to its hard material. For example, the rigid circuit board may stably bear the above mentioned electronic elements and the chips. The rigid circuit board may also stably carry the optical transceiver component when it is located on the circuit board. The rigid circuit board may also be inserted into the electrical connector in the cage of the master monitor.

The circuit board 300 also includes a gold finger 301 formed on a surface of an end thereof. The gold finger is composed of a plurality of independent pins. The circuit board 300 is inserted into the cage 106 and is conductively connected to the electrical connector in the cage 106 through the gold finger 301. The gold finger 301 may be disposed only on a surface of one side (e.g., the upper surface as shown in FIG. 4) of the circuit board 300, or be disposed on surfaces of both upper and lower sides of the circuit board 300 to adapt to occasions where a large number of pins are required. The gold finger 301 is configured to establish electrical connection with the master monitor to achieve power supply, grounding, transmission of an I2C signal, transmission of a data signal, etc. Of course, some optical modules also use flexible circuit boards. The flexible circuit board, as a supplement to the rigid circuit board, may be used in conjunction with the rigid circuit board. For example, a flexible circuit board may be used to connect a rigid circuit board with an optical transceiver component. The optical transceiver component 400 is configured to emit a first optical signal and receive a second optical signal. An optical signal emitted by the optical transceiver component 400 is the first optical signal, and an optical signal received by the optical transceiver component 400 is the second optical signal.

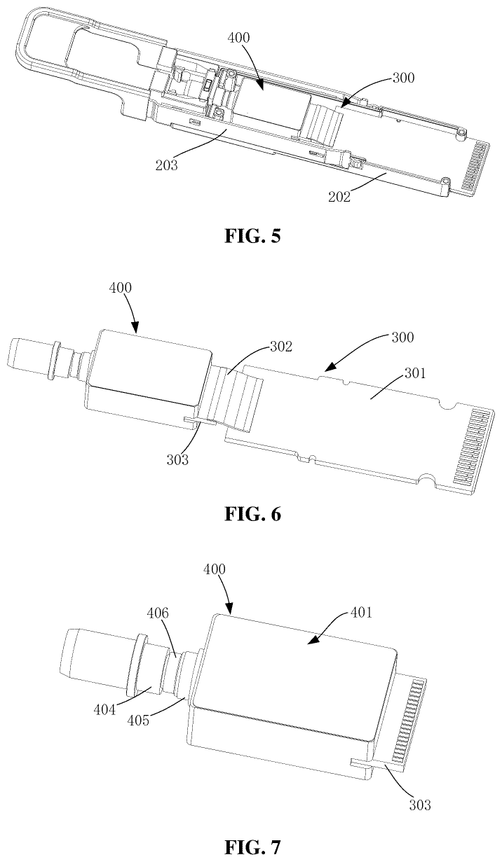

FIG. 5 is a structural diagram of an optical module (the upper shell being removed) provided according to some embodiments of the present disclosure. FIG. 6 is a structural diagram of an optical transceiver component and a circuit board provided according to some embodiments of the present disclosure. As shown in FIG. 4, FIG. 5 and FIG. 6, in some embodiments, the circuit board 300 includes a third circuit board 301 and a second circuit board 302 connected to the third circuit board 301. The third circuit board 301 is a hard circuit board, wherein a first end of the third circuit board is connected to a second end of the second circuit board 302, and a second end of the third circuit board is provided with a gold finger. The second circuit board 302 is a flexible circuit board, a first end of the second circuit board is connected to the optical transceiver component 400, and a second end thereof is connected to the first end of the third circuit board 301.

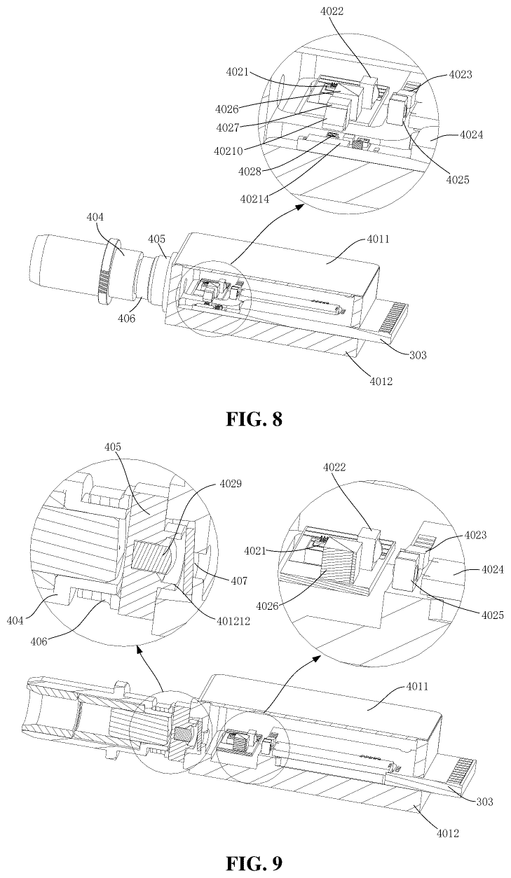

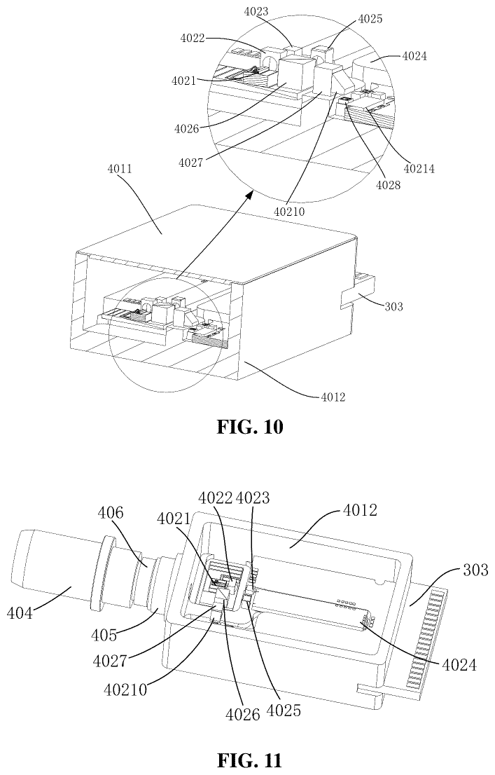

FIG. 7 is a first structural diagram of an optical transceiver component provided according to some embodiments of the present disclosure. FIG. 8 is a first sectional diagram of an optical transceiver component provided according to some embodiments of the present disclosure. FIG. 9 is a second sectional diagram of an optical transceiver component provided according to some embodiments of the present disclosure. FIG. 10 is a third sectional diagram of an optical transceiver component provided according to some embodiments of the present disclosure. As shown in FIG. 7, FIG. 8, FIG. 9, and FIG. 10, in some embodiments, the optical transceiver component 400 includes a transceiver case 401, an optical fiber adapter 404, and a first circuit board 303. A first end of the transceiver case 401 is provided with a through-channel, and the optical fiber adapter 404 is connected to the through-channel. In some examples, the through-channel may be a light hole 401211 as shown in FIG. 17. In some examples, the through-channel may be a fitting groove 4111 as shown in FIG. 26.

As shown in FIG. 17, in some examples, the first end of the transceiver case 401 is provided with a light hole 401211 and a light window 401212, wherein the light hole 401211 acts as the through-channel, and the light window 401212 is disposed corresponding to the light hole 401211. The second end of the transceiver case 401 is provided with an insertion port. The first end of the transceiver case 401 is connected to a lens-fixing seat 405 by laser welding, and the lens-fixing seat 405 is arranged at the light hole 401211 of the transceiver case 401. For example, the lens-fixing seat 405 is welded to the light window 401212. The lens-fixing seat 405 is connected to the optical fiber adapter 404 via a focusing ring 406. The first circuit board 303 is inserted into the transceiver case 401 through the insertion port.

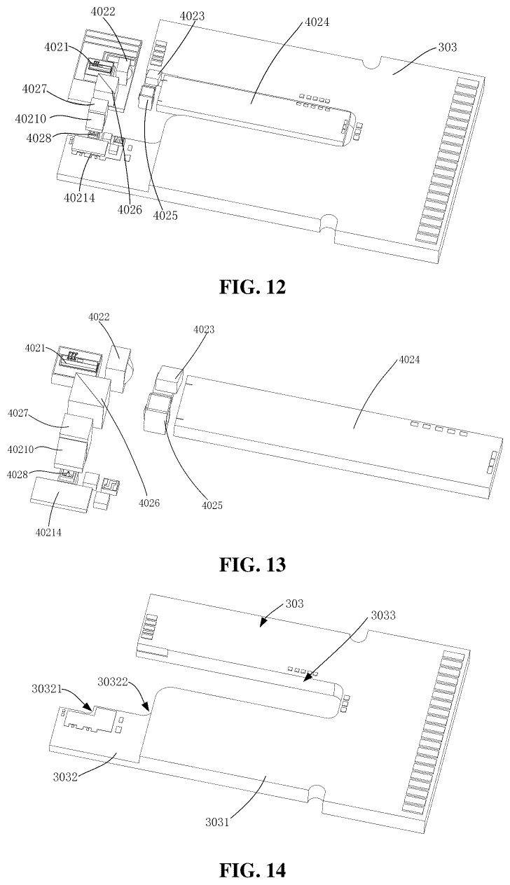

FIG. 11 is a structural diagram of an optical transceiver component (the upper cover being removed) provided in accordance with some embodiments of the present disclosure. FIG. 12 is a structural diagram of an optical component and a first circuit board provided in accordance with some embodiments of the present disclosure. FIG. 13 is a structural diagram of an optical component provided in accordance with some embodiments of the present disclosure. As shown in FIG. 11, FIG. 12 and FIG. 13, in some embodiments, the transceiver case 401 includes an upper cover 4011 and a transceiver seat 4012, wherein the upper cover 4011 covers the transceiver seat 4012, and the upper cover 4011 and the transceiver seat 4012 form a hollow transceiver cavity. Optical components are arranged in the transceiver cavity. The optical components include a laser chip 4021, a first lens 4022, an isolator 4023, an optical modulation chip 4024, a second lens 4025, a filter 4026, a third lens 4027, a receiving-turning prism 40210, an optical reception chip 4028 and a transimpedance amplifier chip 40214. The laser chip 4021, the first lens 4022, the isolator 4023, the optical modulation chip 4024, the second lens 4025, the filter 4026, the third lens 4027, the receiving-turning prism 40210 and the optical reception chip 4028 are all located on the transceiver seat 4012, and the transimpedance amplifier chip 40214 is located on the first circuit board 303.

The laser chip 4021 is a high-power distributed feedback laser chip, and the laser chip 4021 can provide a high-power light. The wavelength of the high-power light emitted by the laser chip 4021 is λ1, and the high-power light emitted by the laser chip 4021 is divergent light. In order to couple the divergent light emitted by the laser chip 4021 to the optical modulation chip 4024, a first lens 4022 is arranged between the laser chip 4021 and the optical modulation chip 4024. The first lens 4022 is configured to couple the high-power light emitted by the laser chip 4021 to the optical modulation chip 4024. The first lens 4022 is a focusing lens, which couples the divergent light to the optical modulation chip 4024.

In addition to being a focusing lens, the first lens 4022 may be a collimating lens and a focusing lens. When the first lens 4022 is a collimating lens and a focusing lens, the first lens 4022 includes a first sub-lens 40221 and a second sub-lens 40222 (see FIG. 23), wherein the first sub-lens 40221 is a collimating lens, and the second sub-lens 40222 is a focusing lens. The first sub-lens 40221 first collimates the divergent light to obtain collimated light. The second sub-lens 40222 then focuses the collimated light and couples it into the optical modulation chip 4024.

The light coupled to the optical modulation chip 4024 through the first lens 4022 may return along its original path, thereby damaging the laser chip 4021. In order to prevent the light coupled to the optical modulation chip 4024 through the first lens 4022 from returning along the original path, an isolator 4023 is provided between the laser chip 4021 and the optical modulation chip 4024.

In a case that the first lens 4022 is a focusing lens, the isolator 4023 is located between the first lens 4022 and the optical modulation chip 4024. In a case that the first lens 4022 is a combination of a collimating lens and a focusing lens, the isolator 4023 is located between the first sub-lens 40221 and the second sub-lens 40222.

In some embodiments, the optical module includes a combination of a DFB laser chip and an optical modulation chip. The optical modulation chip 4024 includes a substrate and an optical modulation film layer, wherein the substrate is a glass substrate, and the optical modulation film layer is laid on the substrate. A thickness of the optical modulation film layer is less than 100 μm. Compared with a silicon photonic chip, the optical modulation chip 4024 has such advantages as low power consumption and low optical loss because the optical modulation chip 4024 is relatively small and its integration accuracy is relatively high. The optical loss of the silicon photonic chip is less than 11.2 dB, and the optical loss of the optical modulation chip 4024 is less than 10 dB.

The optical modulation chip 4024 is arranged in the transceiver seat, and includes a substrate and an optical modulation film layer located on a surface of the substrate; a first bonding pad is arranged on a surface of the optical modulation film layer, and the first bonding pad is electrically connected to the first circuit board; an arc-shaped optical waveguide is arranged inside the optical modulation film layer, and a light inlet and a light outlet of the optical waveguide are located at the same end of the optical modulation film layer. The substrate is a glass substrate, and the optical modulation film layer may be an optical modulation film layer, and the film is laid on the substrate.

The optical modulation chip 4024 may be a lithium niobate chip or a chip made of other materials.

A thickness of the optical modulation film layer is less than 100 μm. In order to reduce the size of the light modulating chip 4024, in some embodiments, the thickness of the optical modulation film layer is less than 20 μm. The optical modulation film layer may be a lithium niobate thin film.

Since the optical loss of the silicon photonic chip is less than 11.2 dB, in order to configure the optical module including a combination of the DFB laser chip and the silicon photonic chip to meet the optical power requirements of the light emitted by 50 G PON, the optical power of the light emitted by the DFB laser chip is greater than 158 mW. Since the optical loss of the optical modulation chip 4024 is less than 10 dB, in order to configure the optical module including a combination of the DFB laser chip and the optical modulation chip to meet the optical power requirements of the light emitted by 50 G PON, the optical power of the light emitted by the DFB laser chip is greater than 80 mW.

The optical power of the light emitted by the high-power DFB laser chip is less than 120 mW. Therefore, in order for the optical module to meet the optical power requirements of the light emitted by 50 G PON, the optical module adopts a combination of DFB laser chip and optical modulation chip.

One side of the optical modulation chip 4024 is provided with an input interface (i.e., light input) and an output interface (i.e., light output). An input optical waveguide, a Mach-Zehnder (MZ) modulator, and an output optical waveguide are provided in the optical modulation chip 4024. The input optical waveguide connects the input interface with the input end of the MZ modulator, and the output optical waveguide connects the output end of the MZ modulator with the output optical interface. High-power light is incident to the input optical waveguide of the optical modulation chip 4024 through the input interface; most of the high-power light received by the input optical waveguide is incident to the input end of the MZ modulator; the MZ modulator modulates the high-power light to obtain a modulated optical signal; the modulated optical signal is output to the output optical waveguide through the output end of the MZM modulator; and most of the modulated optical signals received by the output optical waveguide are output through the output interface. Among them, the modulated optical signal is a divergent optical signal.

The input interface and the output interface of the optical modulation chip 4024 may also be arranged on different sides of the optical modulation chip 4024. However, if the input interface and the output interface of the optical modulation chip 4024 are arranged on different sides of the optical modulation chip 4024, the length of the optical modulation chip 4024 may be increased, thereby increasing the length of the optical module in which the optical modulation chip 4024 is packaged. Therefore, in order to reduce the length of the optical modulation chip 4024, in some embodiments, the input interface and the output interface may be arranged on one side of the optical modulation chip 4024.

A first power monitor and a second power monitor are provided on a surface of the optical modulation chip 4024, wherein the first power monitor is located near the input optical waveguide of the optical modulation chip 4024, and the second power monitor is located near the output optical waveguide of the optical modulation chip 4024. The first power monitor is configured to monitor a small portion of light received by the input optical waveguide to monitor the optical power, and the second power monitor is configured to monitor a small portion of the optical signal received by the output optical waveguide to monitor whether the MZM modulator is at an optimal modulation point.

The optical modulation chip 4024 may modulate the high-power light (optical power emitted by the laser chip >80 mW). The optical loss of the optical modulation film layer modulator (the optical loss is less than 10 dB) is less than the optical loss of the silicon photonic chip (the optical loss is less than 11.2 dB), thus the modulated optical signal can meet the optical power of the light emitted by 50 G PON.

The second lens 4025 is located between the optical modulation chip 4024 and the filter 4026. The second lens 4025 is configured to collimate the optical signal output by the optical modulation chip 4024. The optical signal output by the optical modulation chip 4024 is a divergent optical signal. The second lens 4025 is a collimating lens, which collimates the divergent optical signal output by the optical modulation chip 4024 to obtain a collimated optical signal.

For the convenience of description, an optical signal transmitted from the transceiver case is taken as a first optical signal, and an optical signal enter into the transceiver case is taken as a second optical signal. The filter 4026 is configured to transmit an optical signal of a specific wavelength and reflect the second optical signal to the third lens 4027. The filter 4026 is configured to transmit an optical signal having a wavelength of λ1 and reflect the second optical signal to the third lens 4027.

The filter 4026 may include two 45-degree prisms, wherein hypotenuses of the two 45-degree prisms are bonded, and one of the hypotenuses is coated with a filter film. It may also include one glass sheet, wherein an end of the glass sheet facing the optical fiber adapter is coated with a filter film. The design in which the filter 4026 including two 45-degree prisms is convenient for operation of production process. In the case that the filter 4026 includes one glass sheet, a filter bracket is needed to fix the glass sheet on the transceiver seat.

The third lens 4027 is located between the filter 4026 and the receiving-turning prism 40210, and is configured to couple the second optical signal reflected by the filter 4026 to the receiving-turning prism 40210. The third lens 4027 is a focusing lens, which focuses and couples the second optical signal reflected by the filter 4026 to the receiving-turning prism 40210.

The receiving-turning prism 40210 is configured to change the direction of the second optical signal, and the optical reception chip 4028 receives the second optical signal. Since the photosensitive surface of the optical reception chip 4028 is arranged perpendicular to the third lens 4027, if there is no receiving-turning prism 40210, the optical reception chip 4028 cannot receive the second optical signal. The receiving-turning prism 40210 is located above the optical reception chip 4028. The receiving-turning prism 40210 is configured to change the second optical signal coupled by the third lens 4027, such that the optical reception chip 4028 receives the second optical signal. In order to make the optical reception chip 4028 receive as much of the second optical signal as possible, in some embodiments, the receiving-turning prism 40210 is arranged at the focus of the optical reception chip 4028.

An angle of the receiving-turning prism 40210 is 41° to 43°. The angle of the receiving-turning prism 40210 cannot be set to 45°, to prevent the second optical signal from vertically incident on the optical reception chip and reduce reflection of the second optical signal. For example, the angle of the receiving-turning prism 40210 is 42°, and a main optical axis incident to the optical reception chip 4028 is not perpendicular to the upper surface of the optical reception chip 4028, but forms an angle of 84°. In this way, even a small part of the second optical signal incident on the optical reception chip 4028 is reflected by the optical reception chip, this small part of the second optical signal cannot be reflected back to the optical fiber adapter 404 along its original optical path.

The receiving-turning prism 40210 may be connected to the third lens 4027 or not. The receiving-turning prism 40210 may be connected to the third lens 4027 by a refractive index matching glue. In a case that the receiving-turning prism 40210 is not connected to the third lens 4027, the second optical signal passes through an incident surface of the third lens 4027, an exit surface of the third lens 4027, an incident surface of the receiving-turning prism 40210, a reflection surface of the receiving-turning prism 40210 and an exit surface of the receiving-turning prism 40210 in sequence and then to the optical reception chip.

Light may be reflected at an interface of two different refractive indices. If the receiving-turning prism 40210 is not connected to the third lens 4027, the second light signal is easily reflected at the exit surface of the third lens 4027, and may also be reflected at the incident surface of the receiving-turning prism 40210. However, if the receiving-turning prism 40210 and the third lens 4027 are connected by refractive index matching glue, the light may not be reflected at the exit surface of the third lens 4027 or at the incident surface of the receiving-turning prism 40210 due to the refractive index matching glue, which reduces the light loss of the second light signal and the occupied space in the optical module.

The optical reception chip 4028 is located vertically below the receiving-turning prism 40210, and is configured to convert the received second optical signal into a current signal. The optical reception chip 4028 is provided with a photosensitive surface, on which the second optical signal is received, and the optical reception chip 4028 converts the second optical signal into a current signal.

Since a size of the optical modulation chip is relatively large, in order to package the optical modulation chip in an optical module of a conventional size, the optical modulation chip 4024 is located at a second end of the transceiver seat, and the laser chip 4021, the first lens 4022, the isolator 4023, the second lens 4025, the filter 4026, the third lens 4027, the receiving-turning prism 40210 and the optical reception chip 4028 are all located at the first end of the transceiver seat 4012. Among them, the first end of the transceiver seat 4012 is the first end of the transceiver case 401, and the second end of the transceiver seat 4012 is the second end of the transceiver case 401. The transimpedance amplifier chip 40214 is configured to convert the current signal into a voltage signal.

FIG. 14 is a structural diagram of a first circuit board provided according to some

embodiments of the present disclosure. As shown in FIG. 14, in some embodiments, a first end of the first circuit board 303 is provided with a notch 3033. The existence of the notch 3033 makes the first circuit board 303 has a U-shaped contour. The notch 3033 is configured to arrange the optical modulation chip 4024. In order to facilitate the arrangement of the optical modulation chip 4024, a length of the notch 3033 is greater than or equal to a length of the optical modulation chip 4024, and a width of the notch 3033 is greater than or equal to a width of the optical modulation chip 4024.

A first bonding pad is provided on the optical modulation chip 4024, and a second bonding pad is provided on the first circuit board 303, and the first bonding pad and the second bonding pad are arranged correspondingly. In order to shorten a wire bonding distance between the first bonding pad of the optical modulation chip 4024 and the second bonding pad of the first circuit board 303 as much as possible, in some embodiments, the width of the notch 3033 is equal to the width of the optical modulation chip 4024, and the length of the notch 3033 is equal to the length of the optical modulation chip 4024.

In some embodiments, the first circuit board 303 includes a first sub-circuit board 3031 and a second sub-circuit board 3032, and the first sub-circuit board 3031 and the second sub-circuit board 3032 are integrally formed. The second sub-circuit board 3032 is located at a first end of the first circuit board 303, and the first sub-circuit board 3031 is located at the second end of the first circuit board 303. A second notch area 30322 is provided at an interface of the first sub-circuit board 3031 and the second sub-circuit board 3032, and a first notch area 30321 is provided at the second sub-circuit board 3032. The notch 3033 is provided at the first sub-circuit board 3031. The first notch area 30321 is arranged corresponding to the optical reception chip 4028, and the second notch area 30322 is closer to the gold finger of the first circuit board 303 than the first notch area 30321. An upper surface of the second sub-circuit board 3032 is arranged lower than an upper surface of the first sub-circuit board 3031. That is, the second sub-circuit board 3032 is recessed relative to the first sub-circuit board 3031.

In order to shorten a wire bonding length between the transimpedance amplifier chip 40214 and the optical reception chip 4028 on the transceiver seat 4012 and thus improve the high-frequency performance of the signal line, in some embodiments, a portion of the first sub-circuit board 3031 is dug out to remove several layers so as to obtain the second sub-circuit board 3032, such that the second sub-circuit board 3032 is recessed relative to the first sub-circuit board 3031. The transimpedance amplifier chip 40214 and some resistors and capacitors are arranged on the second sub-circuit board 3032.

A first end of the first sub-circuit board 3031 is close to the laser chip 4021, a second end of the first sub-circuit board 3031 is provided with the gold finger, and a third end of the first sub-circuit board 3031 is close to the optical reception chip 4028. The third end of the first sub-circuit board 3031 is connected to the second sub-circuit board 3032, and the third end of the first sub-circuit board 3031 is not connected to the first end of the first sub-circuit board 3031. The first end of the first sub-circuit board 3031 and the third end of the first sub-circuit board 3031 are both located at the first end of the transceiver seat 4012, and the second end of the first sub-circuit board 3031 is located at the second end of the transceiver seat 4012.

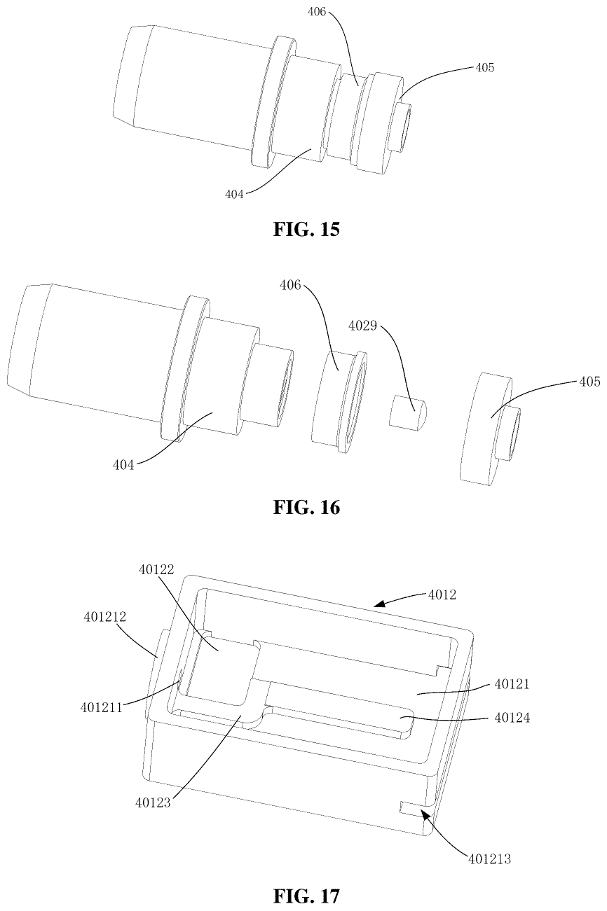

FIG. 15 is a structural diagram of an optical fiber adapter, a focusing ring, a fourth lens, and a lens-fixing seat provided according to some embodiments of the present disclosure. FIG. 16 is an exploded view of an optical fiber adapter, a focusing ring, a fourth lens and a lens-fixing seat provided according to some embodiments of the present disclosure. As shown in FIG. 15 and FIG. 16, in some embodiments, the lens-fixing seat 405 is provided with a storage cavity, and the fourth lens 4029 is placed in the storage cavity. The fourth lens 4029 is bonded to the storage cavity by glue. The fourth lens 4029 is a focusing lens, which is configured to couple the first optical signal passing through the filter 4026 to an optical fiber ferrule in the optical fiber adapter 404, and the focusing lens is also configured to collimate the second optical signal transmitted from the optical fiber ferrule to the filter 4026.

As shown in FIG. 16, in some embodiments, the focusing ring 406 is provided therein with a focusing cavity, and the focusing cavity is engaged with an end of the optical fiber adapter 404 facing the transceiver case 401. During installation, relative positions of the optical fiber adapter 404 and the lens-fixing seat 405 are fixed via optical coupling, and then the optical fiber adapter 404 and the lens-fixing seat 405 are fixed through the focusing ring 406.

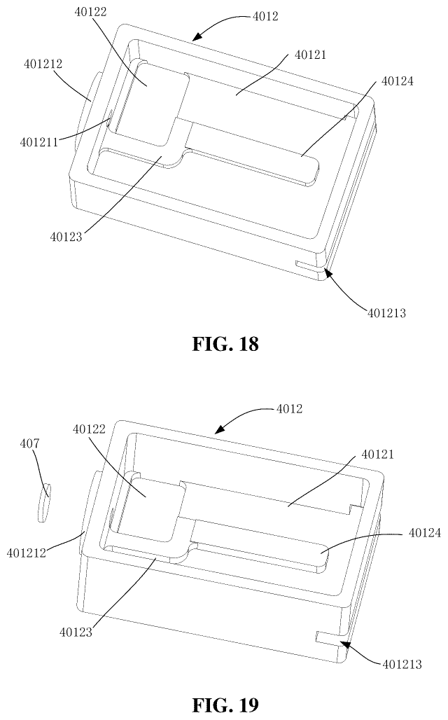

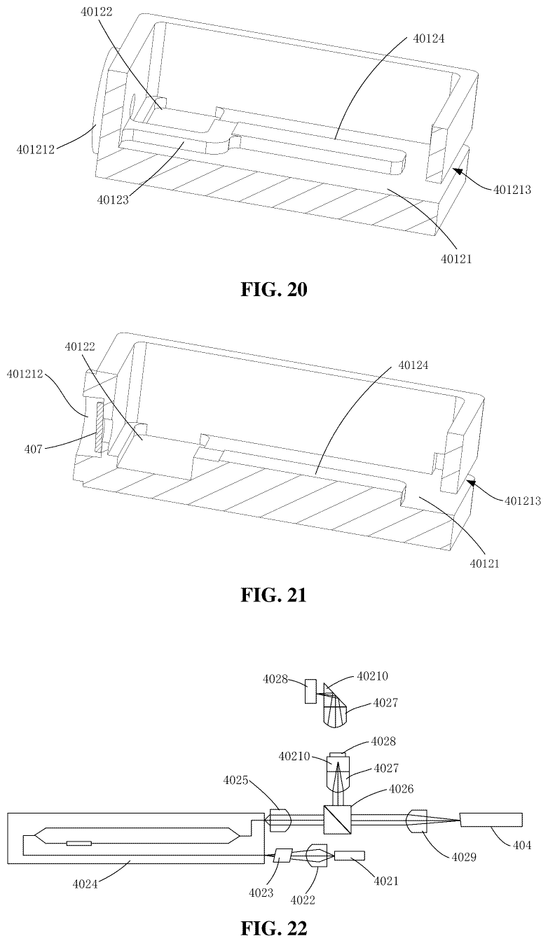

FIG. 17 is a first structural diagram of a transceiver seat provided according to some embodiments of the present disclosure, FIG. 18 is a second structural diagram of a transceiver seat provided according to some embodiments of the present disclosure, FIG. 19 is an exploded diagram of a transceiver seat provided according to some embodiments of the present disclosure, FIG. 20 is a first sectional diagram of a transceiver seat provided according to some embodiments of the present disclosure, and FIG. 21 is a second sectional diagram of a transceiver seat provided according to some embodiments of the present disclosure. As shown in FIG. 17, FIG. 18, FIG. 19, FIG. 20 and FIG. 21, in some embodiments, the first end of the transceiver seat 4012 is provided with a through-channel, such as a light hole 401211. In addition, a light window 401212 is provided at the first end of the transceiver case 4012, and the second end of the transceiver seat 4012 is provided with an insertion port 401213. The light hole 401211 extends from the inner surface of the first end of the transceiver seat 4012 to the outer surface of the first end of the transceiver seat 4012. The light hole 401211 is configured to transmit the first optical signal emitted by the laser chip 4021 out of the transceiver case 401, and the light hole 401211 is also configured to transmit the second optical signal transmitted from the optical fiber adapter 404 into the transceiver case 401.

In order that the first optical signal emitted by the laser chip 4021 can be transmitted out of the transceiver case 401 as much as possible, and that the second optical signal transmitted from the optical fiber adapter 404 can be incident into the transceiver case 401 as much as possible, the light hole 401211 is in a straight line with the second lens 4025 and the filter 4026. The light window 401212 is arranged corresponding to the light hole 401211, and a flat window glass 407 is arranged at the light window 401212. The flat window glass 407 is sealed and welded at the light window 401212. The flat window glass 407 not only facilitates the exiting of the first optical signal and the injection of the second optical signal, but also can seal the transceiver case 401.

The first circuit board 303 is inserted into the transceiver case 401 through the insertion port 401213. In order to make the transceiver case 401 a sealed case, in addition to make the upper cover 4011 sealingly connected to the transceiver seat 4012, and to arrange the flat window glass 407 at the light window of the first end of the transceiver seat 4012, the first circuit board 303 is also connected to the insertion port 401213 by welding. An area of the first circuit board 303 corresponded to the insertion port 401213 is coated with a copper sheet, the transceiver seat 4012 is a metal transceiver seat, and the area of the first circuit board 303 corresponding to the insertion port 401213 is welded to the insertion port 401213 of the transceiver seat 4012 by soldering.

In some embodiments, the transceiver seat 4012 includes a transceiver bottom plate and a transceiver side plate, which together form a cavity without a cover. A first end of the transceiver side plate is provided with the light hole 401211 and the light window 401212, and a second end of the transceiver side plate is provided with the insertion port 401213.

The transceiver bottom plate includes a base body 40121, a storage groove 40122 and a first support protrusion 40123, wherein recessed degrees of the storage groove 40122, the base body 40121 and the first support protrusion 40123 are successively reduced. That is, the storage groove 40122 is recessed relative to the base body 40121, and the base body 40121 is recessed relative to the first support protrusion 40123. The base body 40121 refers to an area of the transceiver bottom plate between the first support protrusion 40123 and the transceiver side plate except the storage groove 40122.

The optical reception chip 4028 is arranged on the base body 40121. A heat sink substrate is arranged on the base body 40121, and the optical reception chip 4028 is arranged on the heat sink substrate. The optical reception chip 4028 is arranged corresponding to the first notch area 30321 of the first circuit board 303. Since an optical path of the second optical signal needs to be turned through the receiving-turning prism, an upper surface of the optical reception chip 4028 should be much lower than an upper surface of the optical modulation chip 4024. However, the upper surface of the first circuit board 303 and the upper surface of the optical modulation chip 4024 are at almost the same height, so the optical reception chip 4028 cannot be placed directly on the first circuit board 303, but is placed on the base body 40121 through the heat sink substrate. That is, the optical reception chip 4028 is bonded to the heat sink substrate, and the heat sink substrate is bonded to the base body 40121.

The storage groove 40122 is located at the first end of the transceiver bottom plate, and is located between the light hole 401211 and the first support protrusion 40123. The storage groove 40122 is configured to place a thermoelectric cooler. The thermoelectric cooler and the optical reception chip 4028 are respectively located at both sides of the first support protrusion 40123. The thermoelectric cooler is configured to control the temperature of the laser chip 4021 such that the laser chip 4021 emits a light of a specific wavelength.

If the thermoelectric cooler is placed directly on the base body 40121, in order to make the optical waveguide of the laser chip 4021 above the thermoelectric cooler and the optical waveguide of the optical modulation chip 4024 on the same horizontal plane, it needs to raise the position of the first support protrusion 40123 (that is, it needs to increase the position height of the first support protrusion), and then the position of the insertion port 401213, the light hole 401211 and the optical reception chip 4028 needs to be raised. If the position of the optical reception chip 4028 is raised, the position of the heat sink substrate under the optical reception chip 4028 also needs to be raised. Therefore, it is not recommended to place the thermoelectric cooler on the base body 40121. If the position of the insertion port 401213 is raised, the first circuit board 303 may be unable to be inserted into the base body 40121 through the insertion port 401213. In this consideration, the thermoelectric cooler cannot be placed directly on the base body 40121.

If the position height of the light hole 401211 is increased, the position height of the optical fiber adapter 404 also needs to be adjusted. Since the position height of the optical fiber adapter 404 is fixed, the position of the light hole 401211 is also fixed, in this regard, the thermoelectric cooler cannot be directly placed on the base body 40121. In order to make the optical waveguide of the laser chip 4021 above the thermoelectric cooler and the optical waveguide of the optical modulation chip 4024 on the same horizontal plane, and not to increase the position height of the first support protrusion 40123, in some embodiments, the thermoelectric cooler is placed in the storage groove 40122, and the storage groove 40122 is recessed relative to the base body 40121.

Considering that the thickness tolerance of the thermoelectric cooler is generally poorly controlled, the height difference between the light outlet of the laser chip 4021 and the input interface of the optical modulation chip 4024 is large, and the first lens 4022 can only couple a small portion of the light of a specific wavelength emitted by the laser chip 4021 to the optical modulation chip 4024, resulting in low coupling efficiency, in some embodiments, a first ceramic substrate is bonded to the thermoelectric cooler so as to avoid this problem.

A second ceramic substrate is disposed on the first ceramic substrate, and the laser chip 4021 and a thermistor are disposed on the second ceramic substrate. With the first ceramic substrate, the height difference between the light outlet of the laser chip 4021 and the input interface of the optical modulation chip 4024 may be reduced, and the light outlet of the laser chip 4021 and the input interface of the optical modulation chip 4024 may be located at the same horizontal plane as much as possible, which facilitates to improve the coupling efficiency.

In addition to the second ceramic substrate, the first lens 4022 and the filter 4026, a switching circuit is arranged on the first ceramic substrate, and the switching circuit is configured to connect the thermoelectric cooler, the laser chip 4021 and the thermistor to the first circuit board 303.

The laser chip 4021 and the thermistor are disposed on the second ceramic substrate. The thermistor is located adjacent to the laser chip 4021 and is configured to monitor a temperature change of the laser chip 4021. In addition to the laser chip 4021 and the thermistor, a circuit is disposed on the second ceramic substrate, and the circuit is configured to connect the laser chip 4021 and the thermistor to the switching circuit.

The first support protrusion 40123 is located on the base body 40121. A first end of the first support protrusion 40123 is connected to the first end of the transceiver side plate, and a second end and sides of the first support protrusion 40123 are not connected to the transceiver side plate.

A second support protrusion 40124 is disposed on the first support protrusion 40123. The first end of the first support protrusion 40123 is connected to the first end of the base body 40121, the second support protrusion 40124 is located at the second end of the base body 40121, and the second end of the first support protrusion 40123 is connected to the second support protrusion 40124. The isolator 4023, the second lens 4025, the third lens 4027 and the receiving-turning prism 40210 are arranged on the first support protrusion 40123, and the optical modulation chip 4024 is arranged on the second support protrusion 40124.

A height of the first support protrusion 40123 is less than or equal to a height of the second support protrusion 40124. A thickness of the optical modulation chip 4024 is about 500 μm, and a height of the second lens 4025 is 1 mm, that is, the height difference between the center of the second lens 4025 and a lower surface of the second lens 4025 is 500 μm. During assembly process of the optical module, a position of the second lens 4025 is to be moved up and down and left and right to achieve coupling between the second lens 4025 and the optical modulation chip 4024. Therefore, a height of the first support protrusion 40123 where the second lens 4025 is located is lower than a height of the second support protrusion 40124 where the optical modulation chip 4024 is located.

However, if the thickness of the optical modulation chip 4024 is about 550 μm, since the height difference between the center of the second lens 4025 and the lower surface of the second lens 4025 is 500 μm, the height of the first support protrusion 40123 where the second lens 4025 is located is equal to the height of the second support protrusion 40124 where the optical modulation chip 4024 is located.

The first support protrusion 40123 includes a first side plate and a second side plate, wherein a first end of the first side plate is connected to the first end of the transceiver side plate, a second end of the first side plate is connected to a first end of the second side plate, a connecting area of the first side plate and the second side plate is arranged corresponding to the second notch area 30322 of the first circuit board 303, a side of a second end of the second side plate is connected to the second support protrusion 40124, the first side plate is connected to a first side wall of the storage groove 40122, and the second side plate is connected to a second side wall of the storage groove 40122, and wherein the first side wall of the storage groove 40122 is connected to the second side wall of the storage groove 40122.

The third lens 4027 and the receiving-turning prism 40210 are disposed on the first side plate, the isolator 4023 and the second lens 4025 are disposed on the first end of the second side plate, and the second support protrusion 40124 is disposed on the second end of the second side plate.

The first support protrusion 40123 is L-shaped. The first side plate and the second side plate of the first support protrusion 40123 form an L-shaped support protrusion.

FIG. 22 is a first optical path diagram of an optical module provided according to some embodiments of the present disclosure. As shown in FIG. 22, in some embodiments, the laser chip 4021 emits a light of a specific wavelength, the first lens 4022 couples the light of the specific wavelength emitted by the laser chip to the optical modulation chip 4024, the light of the specific wavelength is modulated by the optical modulation chip 4024 to obtain a modulated optical signal, the modulated optical signal is collimated by the second lens 4025 to obtain a collimated optical signal, the collimated optical signal passes through the filter 4026 and is coupled to the optical fiber ferrule of the optical fiber adapter 404 by the fourth lens 4029. Among them, a light with a wavelength of λ1 is the light of the specific wavelength.

As can be seen from FIG. 22, in some embodiments, the optical fiber ferrule of the optical fiber adapter 404 emits a second optical signal, the second optical signal is collimated by the fourth lens 4029 to obtain a collimated optical signal, the collimated optical signal is reflected by the filter 4026 to the third lens 4027, the third lens 4027 couples the second optical signal reflected by the filter 4026 to the receiving-turning prism 40210, and the second optical signal is changed in direction by the receiving-turning prism 40210 and is incident to the optical reception chip 4028.

The present application provides an optical module including an optical transceiver component. The optical transceiver component includes a transceiver case and a first circuit board. The transceiver case is disposed, at a first end thereof, with an optical window configured for optical signal to be transmitted out or in, and at a second end thereof, with an insertion port configured for the first circuit board to be inserted, and an optical component is provided in the transceiver case. The first circuit board is provided with a notch. A first optical signal in the transceiver case is transmitted through the optical window, and a second optical signal in the optical fiber adapter is transmitted into the transceiver case through the optical window. The circuit board is inserted in the transceiver case through the insertion port.

In order to ensure sealing between the circuit board and the transceiver case, an area of the circuit board corresponding to the insertion port is disposed with a copper sheet. The transceiver case is a metal transceiver case. The circuit board and the insertion port of the transceiver case are welded and connected to ensure the sealing between the circuit board and the transceiver case. The optical components include a laser chip, a first lens, an optical modulation chip, a second lens, a filter, a third lens, a receiving-turning prism and an optical reception chip. The laser chip, the first lens, the second lens, the filter, the third lens, the receiving-turning prism and the optical reception chip are all located at the first end of the transceiver case, and the optical modulation chip is located at the second end of the transceiver case. The laser chip is a high-power DFB laser chip. The high-power DFB laser chip is configured to emit high-power light.

The first lens is located between the laser chip and the optical modulation chip 4024, and is configured to couple a high-power light to the optical modulation chip 4024. The optical modulation chip 4024 is arranged corresponding to the notch 3033. The optical modulation chip 4024 includes a substrate and an optical modulation film layer, has an optical loss of less than 10 dB, and is configured to modulate the high-power light to obtain a modulated optical signal. The optical modulation film layer is laid on the substrate and has a thickness of less than 100 μm.

It is generally difficult for the light emitted by the DFB laser chip to have an optical power of 120 mW or more at all temperatures. Therefore, in order for the optical module to meet the optical power requirements of the light emitted by 50 G PON, the optical module may only adopt a combination of DFB laser chip and optical modulation chip. The second lens is located between the optical modulation chip and the filter, and the second lens is configured to collimate the modulated optical signal to obtain a collimated optical signal.

The filter is located between the laser chip and the third lens, and the filter is configured to transmit the collimated optical signal to the optical fiber adapter. The third lens is located between the filter and the receiving-turning prism, and the third lens is configured to couple the second optical signal reflected by the filter to the receiving-turning prism.

The receiving-turning prism is located above the optical reception chip, and the receiving-turning prism is configured to change the second optical signal such that the second optical signal is reflected to the optical reception chip. In the present application, the laser chip provides a high-power light, and an optical loss of the optical modulation chip is less than an optical loss of the silicon photonic chip, and thus the modulated optical signal modulated by the optical modulation chip meets the optical power requirement of the light emitted by the 50 G PON.

Since the first lens 402 can be not only a focusing lens, the first lens 4022 can also include a first sub-lens 40221 and a second sub-lens 40222. Wherein, the first sub-lens 40221 is located between the laser chip 4021 and the isolator 4023, the second sub-lens 40222 is located between the isolator 4023 and the optical modulation chip 4024, the first sub-lens 40221 is a collimating lens, and the second sub-lens 40222 is a focusing lens. The filter 4026 may include two 45-degree prisms, with hypotenuses of the two 45-degree prisms being bonded, and one of the hypotenuses being coated with a filter film; alternatively, the filter 4026 may include a glass sheet, wherein one end of the glass sheet facing the optical fiber adapter is coated with a filter film, and the glass sheet is fixed to the transceiver seat through a filter bracket.

The receiving-turning prism 40210 may or may not be connected with the third lens 4027. In some embodiments, a second optical path diagram is provided in addition to the first optical path diagram shown in FIG. 22.

FIG. 23 is a second optical path diagram of an optical module provided according to some embodiments of the present disclosure. As shown in FIG. 23, in some embodiments, the laser chip 4021 emits a light of a specific wavelength, the first sub-lens 40221 collimates the light of the specific wavelength emitted by the laser chip to obtain a collimated light, the second sub-lens 40222 couples the collimated light to the optical modulation chip 4024, the light of the specific wavelength is modulated by the optical modulation chip 4024 to obtain a modulated optical signal, the modulated optical signal is collimated by the second lens 4025 to obtain a collimated optical signal, and the collimated optical signal passes through the filter 4026 and is coupled to the optical fiber ferrule of the optical fiber adapter 404 through the fourth lens 4029.

In some embodiments, the optical fiber ferrule of the optical fiber adapter 404 emits a second optical signal, the second optical signal is collimated by the fourth lens 4029 to obtain a collimated optical signal, the collimated optical signal is reflected by the filter 4026 to the third lens 4027, the third lens 4027 couples the second optical signal reflected by the filter 4026 to the receiving-turning prism 40210, and the second optical signal is changed in direction by the receiving-turning prism 40210 and is incident to the optical reception chip 4028.

In order to achieve connection between the optical transceiver component and an external optical fiber, an optical fiber adapter 404 is provided at one end of the optical transceiver component. The optical fiber adapter 404 is configured to connect the optical transceiver component and the external optical fiber.

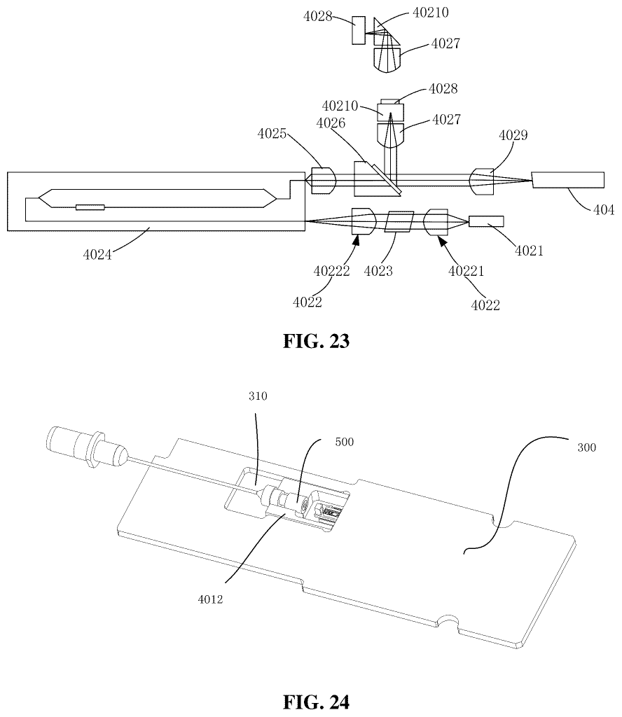

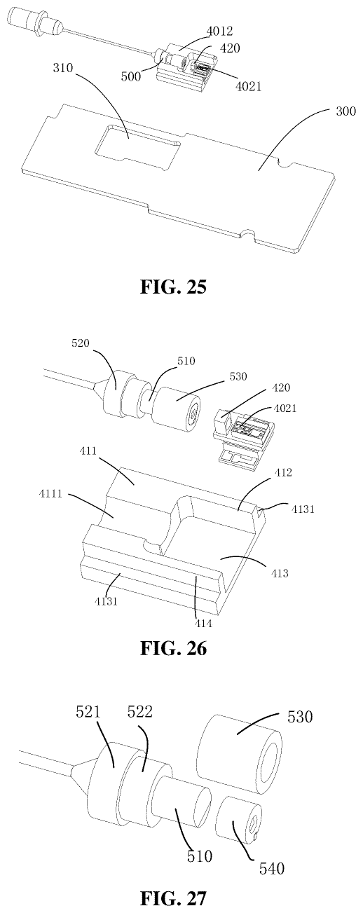

FIG. 24 is a schematic diagram of a connection structure of an optical transceiver component and a circuit board provided according to the present application, and FIG. 25 is a schematic diagram showing that an optical transceiver component and a circuit board provided according to the present application are separated. As shown in FIG. 24 and FIG. 25, in some embodiments of the present application, the circuit board 300 is provided with a through hole 310; the transceiver case 401 is embedded in the through hole 310; and a driving pin is provided on one side of the circuit board adjacent to the through hole, which is connected to the laser chip 4021 and the thermoelectric cooler through wire bonding. The optical fiber adapter 404 is arranged at one end of the transceiver case 401, and a signal light emitted by the laser chip 4021 is coupled to the optical fiber adapter 404 after passing through the lens 420, and then is transmitted to the outside through the optical fiber adapter 404.

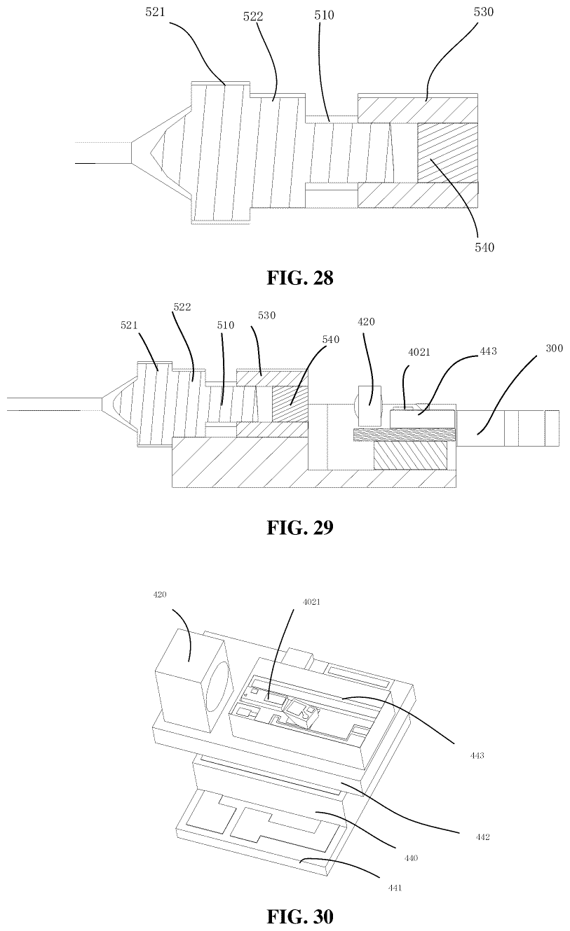

FIG. 26 is a schematic structural diagram of an optical fiber adapter and an optical transceiver component according to an example of the present application, FIG. 27 is an exploded structural diagram of an optical fiber adapter according to an example of the present application, and FIG. 28 is a sectional schematic diagram of an optical fiber adapter of an example of the present application. As shown in FIG. 26, FIG. 27 and FIG.

28, the optical transceiver component includes a transceiver case 401 and a laser chip 4021, a thermoelectric cooler and a lens 420 disposed in the transceiver case 401.

The transceiver seat 4012 of the transceiver case 401 may include an emission base 413 (i.e., a transceiver bottom plate), and a first emission side plate 414 and a second emission side plate 412 disposed at opposite sides of the emission base 413. A bearing plate 411 is disposed between the first emission side plate 414 and the second emission side plate 412. It can be understood that the first emission side plate 414, the second emission side plate 412 and the bearing plate 411 together form a transceiver side plate. Among them, the bearing plate 411 is located at a first end of the transceiver seat 4012. The optical emission chip, the thermoelectric cooler and the lens are disposed on the emission base 413 and are located at an opposite side of the bearing plate 411.

The emission base extends to outsides of the first emission side plate 414 and the second emission side plate 412 to form bearing platforms 4131. Upper surfaces of the bearing platforms 4131 are connected to the lower surface of the circuit board 300, and the bearing platforms 4131 are configured to bear or carry the circuit board.

An upper surface of the bearing plate 411 is recessed downward to form a fitting groove 4111. The fitting groove 4111 acts as a through-channel. The fitting groove 4111 is configured for fixed installation of the optical fiber adapter 404. The fitting groove 4111 is recessed downward relative to the upper surface of the transceiver case 401 and is formed as an arc-shaped configuration.

An optical fiber splice (or optical fiber connector) 500 of the optical fiber adapter 404 includes a flange 520, an optical fiber ferrule 510 and an optical isolator 540. The flange 520 is disposed at one end of the optical fiber ferrule 510, and a sleeve 530 is disposed at the other end of the optical fiber ferrule. The optical isolator 540 is arranged in the sleeve 530. The flange 520 is located outside the optical fiber ferrule 510, and is configured to limit positioning of the optical fiber ferrule 510 in the left-right direction. There is a gap between the flange 520 and the sleeve 530, and a part of the optical fiber ferrule 510 is exposed between the flange and the sleeve.

An inner wall of the flange 520 is connected to the optical fiber ferrule 510, and the flange 520 is sleeved around the optical fiber ferrule 510. The flange 520 has a first connection portion 521 and a second connection portion 522 with different diameters, and the diameter of the first connection portion 521 is larger than the diameter of the second connection portion 522. The second connection portion 522 is embedded in the fitting groove 4111, and the first connection portion 521 is arranged outside of the transceiver case 401, and one end of the first connection portion 521 abuts against a side wall of the transceiver case 401. The first connection portion 521 may be configured to achieve a limitation to the optical fiber adapter 404 in a left-right direction of an optical path propagation direction, that is, the end of the first connection portion 521 abuts against the side wall of the adapting transceiver case 401, so as to achieve the positioning of the optical fiber adapter 404 in the length direction, which facilitates the positioning of the optical fiber adapter 404.

An outer wall of the flange 520 is connected to the fitting groove 4111 through adhesive glue, wherein the end of the first connection portion 521 abuts against the side wall of the transceiver case 401, and a lower outer wall of the second connection portion 522 is connected to the fitting groove 4111 through the adhesive glue.

A diameter of the optical fiber ferrule 510 is smaller than a diameter of the flange. The optical fiber ferrule 510 is partially exposed between the flange and the sleeve. There is a gap between the outer wall of the optical fiber ferrule 510 and the fitting groove 4111. If there is excessive adhesive glue at a position during installation, the excessive glue may run along the fitting groove 4111 and will not adhere to the exposed part of the optical fiber ferrule 510. When determining the position of the optical fiber adapter, it is only necessary to use a detection instrument to detect an outer wall of the optical fiber ferrule 510 exposed between the flange and the sleeve, and then three-dimensional position coordinates of a central axis of the optical fiber ferrule 510 can be obtained, which facilitates consistent of the optical axis of the optical fiber ferrule 510 and that of the optical emission chip during installation.

The optical fiber ferrule is made of ceramic material and has high processing accuracy. The sleeve and the flange are made of metal material, and their processing accuracies are lower than that of the optical fiber ferrule. By using a detection instrument to detect the outer wall of the optical fiber ferrule 510 exposed between the flange and the sleeve, the position of the center axis of the optical fiber ferrule is identified, which is more accurate than determining the position of the center axis of the optical fiber ferrule by identifying an outer wall of the sleeve or the flange, which is beneficial to improving the coupling efficiency of the optical module. The processing accuracy of the optical fiber ferrule is greater than that of the sleeve, and is greater than that of the flange. By identifying the position of the center axis of the optical fiber ferrule through the outer wall of the optical fiber ferrule, the accuracy of the identification is improved, which is beneficial to improving the coupling efficiency of the optical module.

An outer wall of the sleeve 530 is connected to the fitting groove 4111. To increase the firmness of the connection, the sleeve and the fitting groove 4111 are connected through liquid glue. To facilitate the installation of the optical fiber adapter, the diameter of the sleeve is the same as the diameter of the first connection portion of the flange. An opening length of the upper surface of the fitting groove 4111 is not greater than a distance from a left end of the first connection portion of the flange to a right end of the sleeve. A width of the opening of the upper surface of the fitting groove 4111 is greater than the diameter of the optical fiber ferrule 510. With the optical fiber ferrule 510 exposed in the opening of fitting groove 4111, it is convenient to use a detection instrument to detect the outer wall of the optical fiber ferrule 510 exposed between the flange and the sleeve, and the three-dimensional position coordinates of the central axis of the optical fiber ferrule 510 can be obtained, which is convenient for unifying the optical axis of the optical fiber ferrule 510 and that of the optical emission chip during the installation process.

FIG. 29 is a sectional structural schematic diagram of an optical transceiver component provided according to the present application, and FIG. 30 is a partial schematic diagram of an optical transceiver component provided according to the present application. Referring to FIG. 29 and FIG. 30, in order to improve the light coupling efficiency in the optical transceiver component, the optical axis of the optical emission chip and the central axis of the optical fiber ferrule 510 should be kept consistent. During the installation process, a three-dimensional coordinate may be established, and lefts of multiple points may be used to unify the optical axis of the optical emission chip and the central axis of the optical fiber ferrule 510.

A first metal ceramic substrate 441 is disposed on the emission base 413, and a thermoelectric cooler 440 is disposed on the first metal ceramic substrate 441. The first metal ceramic substrate 441 is provided with a cooling drive circuit, which is connected to the circuit board through wire bonding. The cooling drive circuit is configured to drive the thermoelectric cooler 440 to adjust the temperature of the optical transceiver component.

A second ceramic substrate 442 is disposed on the thermoelectric cooler 440, and a lens 420 and a third metal ceramic substrate 443 are disposed on the second ceramic substrate 442. The lens 420 is disposed between the third metal ceramic substrate 443 and the optical fiber ferrule 510, and a laser chip 4021 is disposed on the third metal ceramic substrate 443. The laser chip 4021 emits a signal light toward the optical fiber adapter 404. At this time, the signal light is divergent light, which is formed into a convergent light after passing through the lens. After the convergent light passes through the optical isolator in the optical fiber adapter, the light spot of the convergent light is located at an end face of the optical fiber ferrule 510, and the convergent light is transmitted to the external optical fiber through the optical fiber adapter.

In order to ensure the light coupling efficiency, it is necessary to ensure that the optical axis of the optical emission chip is consistent with that of the optical fiber ferrule 510, and then it is necessary to ensure that a height of the optical axis of the optical emission chip is consistent with a height of the central axis of the optical fiber ferrule 510. The diameter of the optical fiber ferrule 510 is smaller than the diameter of the flange, and the optical fiber ferrule 510 is partially exposed between the flange and the sleeve. There is a gap between the outer wall of the optical fiber ferrule 510 and the fitting groove 4111. During installation, the outer wall of the optical fiber ferrule 510 can be directly measured at the opening of the fitting groove 4111 to determine the position of the central axis of the optical fiber ferrule 510. Therefore, a deviation caused by concentricity deviation between the flange 520 and the optical fiber ferrule 510 when measuring the central axis of the optical fiber ferrule 510 using an outer diameter of the flange is avoided.

The metal ceramic substrate has a high degree of flatness. After determining a height of the center axis of the optical fiber ferrule 510 from an upper surface of the emission base 413, a thickness of the third metal ceramic substrate may be screened such that a light emitting axis of the optical emission chip is in a straight line with the center axis of the optical fiber ferrule 510. Thus, positioning of the optical fiber ferrule 510 and the optical emission chip in the width and thickness directions of the optical module is determined.

In order to ensure the light coupling efficiency, it is also necessary to ensure that a light spot of the signal light emitted by the optical emission chip after being converged by the lens falls on the end face of the optical fiber ferrule 510. Therefore, in order to ensure that the light spot of the signal light emitted by the optical emission chip after being converged by the lens falls on the end face of the optical fiber ferrule 510, it is necessary to ensure a distance between the end face of the optical fiber ferrule 510 and the optical emission chip. For easy installation, the optical fiber ferrule 510 and the optical emission chip are respectively positioned in the length direction of the optical module.

The optical fiber adapter 404 includes the flange 520, the optical fiber ferrule 510 and the optical isolator. Among them, the flange 520 is provided at one end of the optical fiber ferrule 510, and the sleeve is provided at the other end. The optical isolator is arranged in the sleeve. The flange 520 is provided with a first connection portion and a second connection portion with different diameters, and the diameter of the first connection portion is greater than the diameter of the second connection portion. The second connection portion is embedded in the fitting groove 4111, and the first connection portion is arranged outside the optical transceiver case, and one end of the first connection portion abuts against a side wall of the transceiver case. That is, a side wall of the first connection portion is against a side wall of the fitting groove 4111 so as to realize positioning of the optical fiber ferrule 510 in the length direction of the optical module. The optical emission chip is arranged on the upper surface of the third metal ceramic substrate and is located above the emission base 413, and the positioning of the optical emission chip in the length direction of the optical module can be determined by measuring with a certain vertex of the emission base 413 as a reference.

The flange 520 is provided with a first connection portion and a second connection portion of different diameters, and the diameter of the first connection portion is larger than the diameter of the second connection portion. The second connection portion is embedded in the fitting groove 4111, while the first connection portion is arranged outside the transceiver case, and one end of the first connection portion is against a side wall of the transceiver case, and the second connection portion may be configured for limiting to ensure the positioning of the end face of the optical fiber ferrule 510 in the length direction of the optical module. The diameter of the optical fiber ferrule 510 is smaller than a diameter of the flange 520, and the optical fiber ferrule 510 is partially exposed between the flange 520 and the sleeve. There is a gap between the outer wall of the optical fiber ferrule 510 and the fitting groove, and the distance of the upper surface opening of the fitting groove 4111 in the width direction of the optical module is greater than the diameter of the optical fiber ferrule 510. When determining the position of the optical fiber adapter, it is only necessary to detect the outer wall of the optical fiber ferrule 510 exposed between the flange 520 and the sleeve by using a detection instrument, and the optical fiber ferrule 510 can be identified in the width and height directions of the optical module by identifying a cylindrical surface of the outer wall of the optical fiber ferrule 510. Then, by selecting the thickness of the third metal ceramic substrate configured to carry the optical emission chip, the optical axis of the optical fiber ferrule 510 may be made to be consistent with that of the optical emission chip, ensuring the positioning of the optical fiber ferrule 510 and the optical emission chip in the width and height directions of the optical module.

In some embodiments, the fitting groove 4111 is an arc-shaped configuration, which matches outer walls of the flange 520 and the sleeve. For easy installation, the diameter of the second connection portion of the flange 520 is the same as the diameter of the sleeve. During installation, one end of the optical fiber adapter that is not connected to an optical fiber may be inserted through one side of the fitting groove 4111 until a side wall of the first connection portion of the flange 520 abuts against the corresponding end of the fitting groove 4111. In order to achieve the installation and positioning of the optical fiber adapter, a width of the opening of the fitting groove 4111 on the upper surface is smaller than the diameter of the second connection portion of the flange 520, and is larger than the diameter of the optical fiber ferrule 510. The optical fiber ferrule 510 is partially exposed between the flange 520 and the sleeve, and there is a gap between the outer wall of the optical fiber ferrule 510 and the fitting groove. If there is excessive adhesive glue at a local portion during installation, the excessive glue may run along the fitting groove 4111 and will not adhere to the exposed part of the optical fiber ferrule 510. When determining the position of the optical fiber adapter, it is only necessary to use a detection instrument to detect the outer wall of the optical fiber ferrule 510 exposed between the flange 520 and the sleeve, and then three-dimensional position coordinates of the central axis of the optical fiber ferrule 510 can be obtained, which facilitates the unification of the optical axis of the optical fiber ferrule 510 and that of the optical emission chip during installation.

In order to facilitate installation and timely observe the installation position of the optical fiber adapter, an avoidance portion is formed on one side of the fitting groove 4111 adjacent to the optical emission chip. The avoidance portion is located at a bottom of the fitting groove 4111, such that part of the optical fiber adapter is exposed inside the transceiver case. An end face of the optical fiber adapter is parallel to an end face of the fitting groove 4111 adjacent to the optical emission chip, which facilitates the installation and fixation of the optical fiber adapter and prevents the optical fiber adapter from protruding from the fitting groove 4111, which is beneficial to prevent the optical fiber adapter from being damaged by external force during installation and transportation.

In some embodiments, the optical fiber ferrule 510 is coaxially arranged with the flange 520, and the optical fiber ferrule 510 is coaxially arranged with the sleeve, so as to facilitate the positioning of the optical fiber ferrule 510 during the installation process.

Finally, it should be noted that the above embodiments are only used to illustrate the technical solutions of the present disclosure, rather than to limit them. Although the present disclosure has been described in detail with reference to the aforementioned embodiments, those skilled in the art should understand that modifications may be made to the technical solutions of the aforementioned embodiments, or equivalent replacements may be made to some of the technical features of them. However, these modifications or replacements do not deviate the essence of the corresponding technical solutions from the spirit and scope of the technical solutions of the embodiments of the present disclosure.

1. An optical module, comprising:
an optical transceiver component comprising a transceiver case and a first circuit board, wherein
a first end of the transceiver case is formed with a through-channel; a second end of the transceiver case is formed with an insertion port, the insertion port being configured for the first circuit board to be inserted into the transceiver case; and an optical component is disposed in the transceiver case; and
the first circuit board is formed with a notch;
the optical component comprises a laser chip, a first lens, an optical modulation chip, a second lens, a filter, a third lens, a receiving-turning prism and an optical reception chip, wherein,
the laser chip, the first lens, the second lens, the filter, the receiving-turning prism, the third lens and the optical reception chip are all located at the first end of the transceiver case, and the optical modulation chip is located at the second end of the transceiver case;
the first lens is located between the laser chip and the optical modulation chip;
the optical modulation chip is arranged corresponding to the notch, and the optical modulation chip comprises a substrate and an optical modulation film layer laid on the substrate, wherein a first bonding pad is disposed on a surface of the optical modulation film layer, and the first bonding pad is electrically connected to the first circuit board; an arc-shaped optical waveguide is disposed inside the optical modulation film layer, and a light inlet and a light outlet of the optical waveguide are located at the same end of the optical modulation film layer;
the second lens is located between the optical modulation chip and the filter;
the filter is located between the laser chip and the third lens; and
the receiving-turning prism is located above the optical reception chip.

2. The optical module according to claim 1, wherein the transceiver case comprises a transceiver side plate and a transceiver bottom plate, and wherein
the transceiver side plate and the transceiver bottom plate form a cavity without a cover; a first end of the cavity is provided with the through-channel, and a second end of the cavity is provided with the insertion port;
the through-channel extends from an inner surface of a first end of the transceiver side plate to an outer surface of the first end of the transceiver side plate;
the transceiver bottom plate is provided with a base body, a storage groove and a first support protrusion, wherein a first end of the first support protrusion is connected to the first end of the transceiver side plate, and sides and a second end of the first support protrusion are not connected to the transceiver side plate; and recessed degrees of the first support protrusion, the base body and the storage groove increase in sequence; and
the optical reception chip is arranged on the base body.

3. The optical module according to claim 2, wherein the first support protrusion comprises a first side plate and a second side plate, and wherein
a first end of the first side plate is connected to the first end of the transceiver side plate, a second end of the first side plate is connected to the second side plate, and the third lens is disposed on the first side plate; and
the second side plate is provided thereon with a second support protrusion and the second lens, wherein the second support protrusion is arranged corresponding to the notch, and the optical modulation chip is arranged on the second support protrusion.

4. The optical module according to claim 3, wherein a height of the first support protrusion is less than or equal to a height of the second support protrusion.

5. The optical module according to claim 3, further comprising a second circuit board and a third circuit board, wherein:
a first end of the second circuit board is connected to a second end of the first circuit board, a first end of the third circuit board is connected to a second end of the second circuit board, and a second end of the third circuit board is provided with a gold finger;
a first end of the first circuit board is inserted into the transceiver case through the insertion port, and the first circuit board comprises a first sub-circuit board and a second sub-circuit board, wherein,
the second sub-circuit board is provided with a first notch area, and the first notch area is recessed relative to the first sub-circuit board;
the first notch area is arranged corresponding to the optical reception chip;
a second notch area is provided at an interface of the first sub-circuit board and the second sub-circuit board, and the first sub-circuit board is provided with the notch; the second notch area is arranged corresponding to a connection area between the first side plate and the second side plate, and the second notch area is arranged closer to the gold finger of the first circuit board than the first notch area; and
the notch is arranged corresponding to the second support protrusion.

6. The optical module according to claim 1, wherein
the filter comprises two 45-degree prisms, hypotenuses of the two 45-degree prisms being bonded, and one of the hypotenuses being coated with a filter film; or
the filter comprises only one glass sheet, wherein a filter film is coated on a side of the glass sheet facing the through-channel.

7. The optical module according to claim 1, wherein the first lens is a focusing lens; or the first lens comprises a collimating lens and a focusing lens.

8. The optical module according to claim 1, wherein the receiving-turning prism is connected to the third lens; or the receiving-turning prism is not connected to the third lens; wherein an angle of the receiving-turning prism is 41° to 43°.

9. The optical module according to claim 2, wherein a thermoelectric cooler is disposed in the storage groove;
the thermoelectric cooler is provided thereon with a first ceramic substrate;
the first ceramic base is provided thereon with a second ceramic substrate, the first lens and the filter; and
the laser chip and a thermistor are arranged on the second ceramic substrate, wherein the thermistor is configured to monitor a temperature change of the laser chip.

10. The optical module according to claim 2, wherein the transceiver case comprises:
a transceiver seat, one end of which is provided with the through-channel, and the other end of which is provided with the insertion port; the transceiver side plate and the transceiver bottom plate together form the transceiver seat; and
an upper cover covering the transceiver base;
wherein, the optical transceiver component further includes an optical fiber adapter, the optical fiber adapter is connected to the through-channel, and the light outlet faces the optical fiber adapter; and
a light exit direction of the laser chip is away from the optical fiber adapter and faces the light inlet of the optical waveguide.

11. The optical module according to claim 10, wherein the optical transceiver component further comprises a lens-fixing seat;
a light hole is formed at a first end of the transceiver seat, the light hole acts as the through-channel and is configured for a light signal to be transmitted in or out; a light window is disposed at the first end of the transceiver seat, the light window being arranged corresponding to the light hole; the lens-fixing seat is connected to the light window, and the optical fiber adapter is connected to the lens-fixing seat through a focusing ring;
a fourth lens is arranged in the lens-fixing seat, and the fourth lens is configured to couple an optical signal transmitted through the filter to the optical fiber adapter, and is further configured to collimate a second optical signal transmitted from the optical fiber adapter to the filter.

12. The optical module according to claim 10, wherein a first end of the transceiver seat has a bearing plate, an upper surface of the bearing plate being recessed downward to form a fitting groove, and the fitting groove acting as the through-channel;
the optical fiber adapter is embedded in the fitting groove, and the optical fiber adapter comprises:
an optical fiber ferrule;
a flange sleeved on an outer side of the optical fiber ferrule, the flange comprising a first connection portion and a second connection portion with different diameters;
a sleeve sleeved on an outer side of the optical fiber ferrule and provided therein with an optical isolator, wherein
one side of the first connection portion abuts against a side wall of the fitting groove, and the second connection portion is embedded in the fitting groove;
the flange is not in contact with the sleeve, and a portion of the optical fiber ferrule is exposed between the flange and the sleeve; and
a processing accuracy of the optical fiber ferrule is greater than that of the sleeve.

13. The optical module according to claim 12, wherein the first connection portion and the second connection portion are cylindrical, and a diameter of the first connection portion is greater than a diameter of the second connection portion.

14. The optical module according to claim 12, wherein a diameter of the optical fiber ferrule is smaller than a diameter of the second connection portion; and a diameter of the optical fiber ferrule is smaller than a diameter of the sleeve.

15. The optical module according to claim 12, wherein
the optical fiber ferrule is coaxially arranged with the flange; and
the optical fiber ferrule is coaxially arranged with the sleeve.

16. The optical module according to claim 12, wherein a width of an opening of the fitting groove on the upper surface is greater than a diameter of the optical fiber ferrule.

17. The optical module according to claim 12, wherein a width of an opening of the fitting groove on the upper surface is smaller than a diameter of the second connection portion, and is smaller than a diameter of the sleeve.

18. An optical module, comprising:
an optical transceiver component comprising a transceiver case, a first circuit board and an optical fiber adapter, wherein
a first end of the transceiver case is provided with a through-channel, the through-channel being configured to connect the optical fiber adapter; a second end of the transceiver case is provided with an insertion port, the insertion port being configured for the first circuit board to be inserted into the transceiver case; and an optical component is disposed in the transceiver case; and
the first circuit board is formed with a notch;
the optical components comprises a laser chip, an optical modulation chip and an optical reception chip, wherein,
the laser chip and the optical reception chip are both located at the first end of the transceiver case, and the optical modulation chip is located at the second end of the transceiver case;
the optical modulation chip is arranged corresponding to the notch; a light outlet of the optical modulation chip faces the optical fiber adapter; a light exit direction of the laser chip faces away from the optical fiber adapter and faces a light inlet of the optical modulation chip; and
the transceiver case comprises a transceiver seat, one end of which is provided with the through-channel, and the other end is provided with the insertion port; and an upper cover covering the transceiver base.

19. The optical module according to claim 18, wherein
a first end of the transceiver seat has a bearing plate, an upper surface of the bearing plate being recessed downward to form a fitting groove, and the fitting groove being the through-channel; and
the optical fiber adapter is embedded in the fitting groove, and the optical fiber adapter comprises:
an optical fiber ferrule;
a flange is sleeved on an outer side of the optical fiber ferrule, the flange comprising a first connection portion and a second connection portion with different diameters;
a sleeve sleeved on an outer side of the optical fiber ferrule and provided therein with an optical isolator;
one side of the first connection portion abuts against a side wall of the fitting groove, and the second connection portion is embedded in the fitting groove; and
the flange is not in contact with the sleeve, and a portion of the optical fiber ferrule is exposed between the flange and the sleeve.

20. The optical module according to claim 19, wherein the first connection portion and the second connection portion are cylindrical, and a diameter of the first connection portion is greater than a diameter of the second connection portion.
